(19) United States
(12) Patent Application Publication
(10) Pub. No.: US 2019/0016338 A1
(43) Pub. Date: Jan. 17, 2019

(54) VEHICLE CONTROL DEVICE, VEHICLE CONTROL METHOD, AND VEHICLE CONTROL PROGRAM

(71) Applicant: HONDA MOTOR CO., LTD., Minato-ku, Tokyo (JP)

(72) Inventors: Atsushi Ishioka, Wako-shi (JP); Toru Kokaki, Wako-shi (JP); Daichi Kato, Wako-shi (JP)

(21) Appl. No.: 16/067,625

(22) PCT Filed: Feb. 8, 2017
(86) PCT No.: PCT/JP2017/004576

§ 371 Date: Jul. 2, 2018

(30) Foreign Application Priority Data
Feb. 18, 2016 (JP) 2016-028721

(51) Int. Cl. B60W 30/18; B60W 30/095; B60W 40/04; G08G 1/16

(52) U.S. Cl. CPC B60W 30/18163; B60W 30/0953; B60W 30/0956; B60W 40/04; B60W 2550/308; G08G 1/166; B60W 2550/306; B60W 2550/302; B60W 2550/304; G08G 1/167

(57) ABSTRACT

A vehicle control device includes: a recognition unit configured to recognize a position of a neighboring vehicle traveling around a host vehicle; a target position setting unit configured to set a target position for lane change to a lane of a lane change destination to which the host vehicle changes a lane; a lane changeability determining unit configured to determine that it is possible to change lane when one or both of a first condition in which the neighboring vehicle is not present in a forbidden area which is set on a lateral side of the host vehicle and on the lane of the lane change destination and a second condition in which a collision margin time between the host vehicle and the neighboring vehicle present before or after the target position is larger than a threshold are satisfied; and a control unit configured to cause the host vehicle to change lane to the lane of the lane change destination when the lane changeability determining unit determines that it is possible to change the lane.

### TECHNICAL FIELD

The present invention relates to a vehicle control device, a vehicle control method, and a vehicle control program.

This application claims the priority benefit of Japanese Patent Application No. 2016-028721, filed on Feb. 18, 2016, the contents of which are hereby incorporated by reference into the present application.

### BACKGROUND ART

In recent years, research on technology for allowing a vehicle to automatically change its lane during traveling according to a relative relationship between a host vehicle and neighboring vehicles has progressed. In this regard, a travel control device is known that acquires a traffic state including a vehicle density of each lane of a road on which vehicles are traveling, causes a vehicle to change lane to a lane having a higher vehicle density among the lanes, and performs travel control so that it is difficult for the inter-vehicle distance to become short the closer to a threshold density the vehicle density for the vehicle that has changed lane to the lane having a higher vehicle density is (for example, see Patent Literature 1). Moreover, a vehicle positional relationship display device is known that detects the positions of vehicles on a road on which the vehicles are traveling, causes the vehicles to perform inter-vehicle communication to exchange the detected position information on the vehicles, recognizes a rearmost vehicle in a row of vehicles traveling in an automatic driving mode near a host vehicle from the position information of other vehicles traveling along an automatic traveling lane on the same road, received via the inter-vehicle communication, and displays a relative positional relationship between the host vehicle and the recognized rearmost vehicle (for example, see Patent Literature 2).

### CITATION LIST

### Patent Literature

[Patent Literature 1]

Japanese Unexamined Patent Application, First Publication No. 2010-036862

[Patent Literature 2]

Japanese Unexamined Patent Application, First Publication No. 10-103982

### SUMMARY OF INVENTION

### Technical Problem

However, conventionally, it was not possible to determine whether it is possible to change a traveling lane appropriately on the basis of the state of a lane of a lane change destination.

Aspects of the present invention are made in view of such a circumstance, and one of the objects thereof is to provide a vehicle control device, a vehicle control method, and a vehicle control program capable of making lane changeability determination appropriately.

### Solution to Problem

(1) A vehicle control device according to an aspect of the present invention includes: a recognition unit configured to recognize a position of a neighboring vehicle traveling around a host vehicle; a target position setting unit configured to set a target position for lane change to a lane of a lane change destination to which the host vehicle changes a lane; a lane changeability determining unit configured to determine that it is possible to change lane when one or both of a first condition in which the neighboring vehicle is not present in a forbidden area which is set on a lateral side of the host vehicle and on the lane of the lane change destination and a second condition in which a collision margin time between the host vehicle and the neighboring vehicle present before or after the target position is larger than a threshold are satisfied; and a control unit configured to cause the host vehicle to change lane to the lane of the lane change destination when the lane changeability determining unit determines that it is possible to change the lane.

(2) In the aspect (1), the lane changeability determining unit may determine that it is possible to change lane when both the first condition and the second condition are satisfied, and the lane changeability determining unit may determine that it is not possible to change lane when at least one of the first condition and the second condition is not satisfied.

(3) In the aspect (1), the lane changeability determining unit may determine that it is possible to change lane when at least one of the first condition and the second condition is satisfied, and the lane changeability determining unit may determine that it is not possible to change lane when both the first condition and the second condition are not satisfied.

(4) In any one of the aspects (1) to (3), the control unit may generate a target trajectory of the host vehicle on the basis of positions at predetermined future time points of the host vehicle and control acceleration/deceleration and steering of the host vehicle so that the host vehicle travels along the target trajectory, the vehicle control device may further include: an interference determining unit configured to generate an other-vehicle expected trajectory on the basis of positions at the predetermined future time points of the neighboring vehicle and determines whether the target trajectory of the host vehicle and the other-vehicle expected trajectory interfere with each other on the basis of distances between the positions on the target trajectory of the host vehicle and positions corresponding in relation to time points to the positions on the target trajectory of the host vehicle among positions on the other-vehicle expected trajectory, and the lane changeability determining unit may determine that it is possible to change lane when the interference determining unit determines that the target trajectory of the host vehicle does not interfere with the other-vehicle expected trajectory.

(5) In the aspect (4), the determination on lane changeability using the first condition and the second condition and the determination by the interference determining unit may be performed repeatedly.

(6) A vehicle control method according to another aspect of the present invention causes an onboard computer to execute: recognizing a position of a neighboring vehicle traveling around a host vehicle; setting a target position for lane change to a lane of a lane change destination to which the host vehicle changes a lane; determining that it is possible to change lane when one or both of a first condition in which the neighboring vehicle is not present in a forbidden area which is set on a lateral side of the host vehicle and on the lane of the lane change destination and a second condition in which a collision margin time between the host vehicle and the neighboring vehicle present before or after the target position is larger than a threshold are satisfied; and causing the host vehicle to change lane to the lane of the lane change destination when it is determined that it is possible to change the lane.

(7) A vehicle control program according to another aspect of the present invention causes an onboard computer to execute processes including: recognizing a position of a neighboring vehicle traveling around a host vehicle; setting a target position for lane change to a lane of a lane change destination to which the host vehicle changes a lane; determining that it is possible to change lane when one or both of a first condition in which the neighboring vehicle is not present in a forbidden area which is set on a lateral side of the host vehicle and on the lane of the lane change destination and a second condition in which a collision margin time between the host vehicle and the neighboring vehicle present before or after the target position is larger than a threshold are satisfied; and causing the host vehicle to change lane to the lane of the lane change destination when it is determined that it is possible to change the lane.

### Advantageous Effects of Invention

According to the aspects (1), (6), and (7), the control unit can perform lane changeability determination appropriately during automatic driving control. Therefore, it is possible to change lane at an appropriate timing according to a traveling state of a vehicle on a lane change destination.

According to the aspect (2), since the control unit determines that it is possible to change lane when both conditions of the first condition based on the presence of another vehicle in the forbidden area and the second condition based on the collision margin time of the host vehicle and the other vehicle are satisfied, it is possible to change lane at a more appropriate timing.

According to the aspect (3), the control unit can determine that it is possible to change lane when either the first condition or the second condition is not satisfied. In this way, it is possible to broaden the allowable range of the lane changeability.

According to the aspect (4), the control unit can determine the lane changeability more appropriately by determining whether the traveling positions interfere using the expected trajectories of the host vehicle and the other vehicle traveling on the lane of the lane change destination.

According to the aspect (5), since the determination on lane changeability using the first condition and the second condition and the determination by the interference determining unit are performed repeatedly during traveling of the host vehicle, the control unit can determine the lane changeability according to a change in a traveling state.

### BRIEF DESCRIPTION OF DRAWINGS

FIG. 1 is a diagram illustrating components of a vehicle on which a vehicle control system according to a first embodiment is mounted.

FIG. 2 is a diagram illustrating a functional configuration of a host vehicle on which the vehicle control system according to the first embodiment is mounted.

FIG. 3 is a diagram illustrating how a host vehicle position recognition unit recognizes a relative position of a host vehicle in relation to a traveling lane.

FIG. 4 is a diagram illustrating an example of an action plan generated for a certain segment.

FIG. 5A is a diagram illustrating an example of a trajectory generated by a first trajectory generating unit.

FIG. 5B is a diagram illustrating an example of a trajectory generated by a first trajectory generating unit.

FIG. 5C is a diagram illustrating an example of a trajectory generated by a first trajectory generating unit.

FIG. 5D is a diagram illustrating an example of a trajectory generated by a first trajectory generating unit.

FIG. 6 is a diagram illustrating how a target position setting unit according to the first embodiment sets a target position.

FIG. 7 is a diagram illustrating how a second trajectory generating unit according to the first embodiment generates a trajectory.

FIG. 8 is a diagram describing determination on interference between a target trajectory of a host vehicle and an other-vehicle expected trajectory.

FIG. 9 is a diagram illustrating an example of trajectories generated when there is a need to change a lane.

FIG. 10 is a flowchart illustrating an example of a lane change control process.

FIG. 11 is a flowchart illustrating an example of a lane changeability determining process according to the first embodiment.

FIG. 12 is a flowchart illustrating an example of a target position changing process.

FIG. 13 is a diagram describing how a target position is changed to a front side.

FIG. 14 is a diagram describing how a target position is changed to a side behind.

FIG. 15 is a flowchart illustrating an example of a lane changeability determining process according to a second embodiment.

### DESCRIPTION OF EMBODIMENTS

Hereinafter, embodiments of a vehicle control device, a vehicle control method, and a vehicle control program according to the present invention will be described with reference to the drawings.

### <First Embodiment>

### [Configuration of Vehicle]

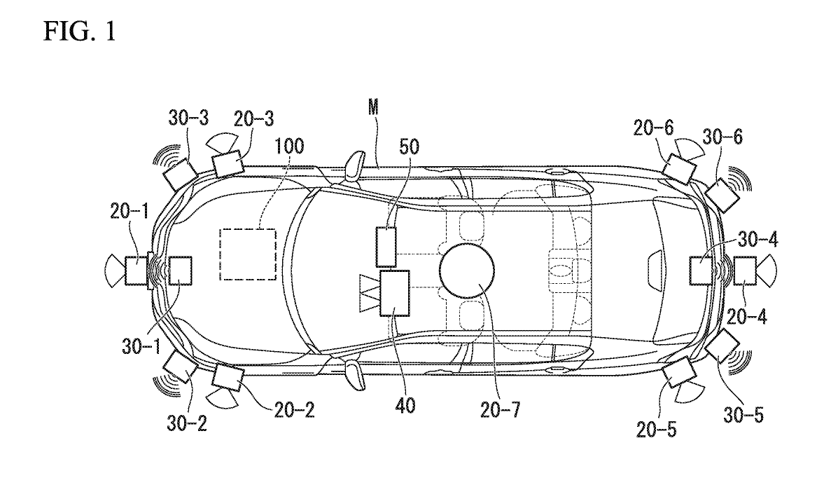

FIG. 1 is a diagram illustrating components of a vehicle (hereinafter referred to as a host vehicle M) on which a vehicle control system 1 according to a first embodiment is mounted. A vehicle on which the vehicle control system 1 is mounted is an automobile such as a two-wheeled automobile, a three-wheeled automobile, or a four-wheeled automobile, for example, and examples thereof include an automobile which uses an internal combustion engine such as a diesel engine or a gasoline engine as a power source, an electric automobile which uses a motor as a power source, and a hybrid automobile which uses an internal combustion engine and a motor as a power source. Moreover, the electric automobile is driven using electric power discharged by a battery such as, for example, a secondary battery, a hydrogen fuel cell, a metal fuel cell, or an alcohol fuel cell.

As illustrated in FIG. 1, sensors such as finders 20-1 to 20-7, radars 30-1 to 30-6, and a camera 40, a navigation device 50, and a vehicle control device 100 are mounted on the host vehicle M. The finders 20-1 to 20-7 use a light detection and ranging or a laser imaging detection and ranging (LIDAR) that measures scattered light of emission light to measure a distance to a target, for example. For example, the finder 20-1 may be attached to a front grille or the like, and the finders 20-2 and 20-3 may be attached to a side surface of a vehicle body, a door mirror, the inside of a head light, the vicinity of a side indicator light, or the like. The finder 20-4 may be attached to a trunk lid or the like, and the finders 20-5 and 20-6 are attached to a side surface of the vehicle body, the inside of a tail lamp, or the like. The finders 20-1 to 20-6 may have a detection area which is approximately 150° with respect to a lateral direction, for example. Moreover, the finder 20-7 may be attached to a roof lamp or the like. The finder 20-7 has a detection area which is at 360° with respect to a horizontal direction, for example.

The radars 30-1 and 30-4 are long-range millimeter-wave radars of which the detection area in a depth direction, for example, is wider than other radars. Moreover, the radars 30-2, 30-3, 30-5, and 30-6 are mid-range millimeter-wave radars of which the detection area in the depth direction is narrower than the radars 30-1 and 30-4. Hereinafter, the finders 20-1 to 20-7 will be referred to simply as a “finder 20” when the finders are not particularly distinguished, and the radars 30-1 to 30-6 will be referred to simply as a “radar 30” when the radars are not particularly distinguished. The radar 30 detects the presence of an object (for example, a neighboring vehicle (other vehicle), an obstacle, or the like) around a host vehicle M, the distance to an object, a relative speed, and the like according to a frequency modulated continuous wave (FM-CW) scheme, for example.

The camera 40 is a digital camera which uses a solid-state imaging device such as a charge coupled device (CCD) or a complementary metal oxide semiconductor (CMOS), for example. The camera 40 is attached to an upper portion of a front windshield or to a rear surface of a rear-view mirror. The camera 40 captures the images of the side in front of the host vehicle M periodically and repeatedly, for example.

The components illustrated in FIG. 1 are examples only, and some of the components may be omitted and other components may be added.

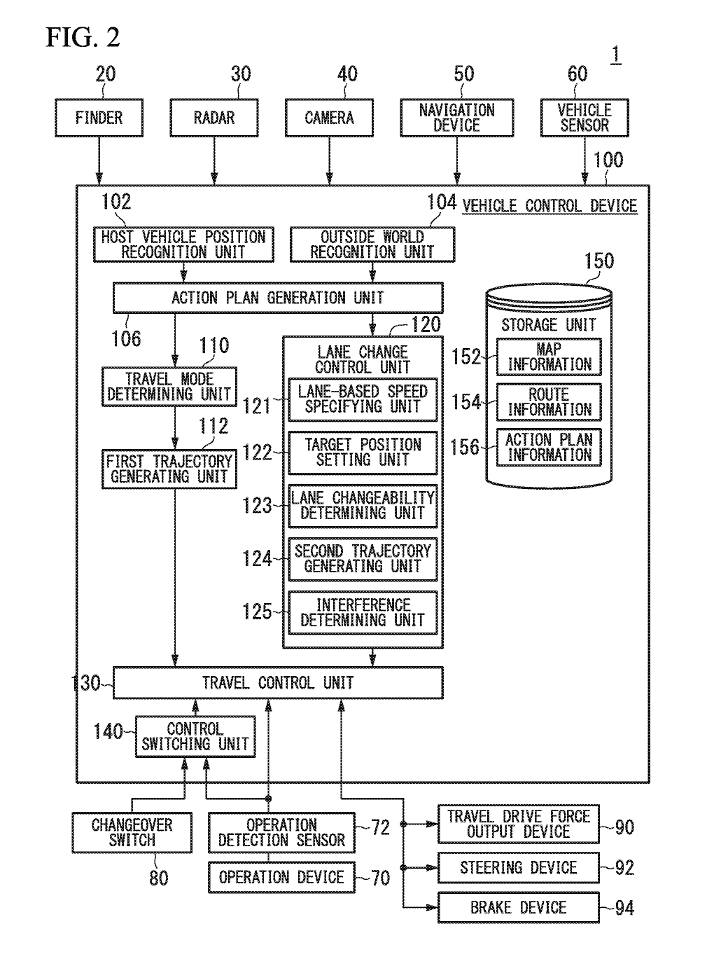

FIG. 2 is a diagram illustrating a functional configuration of the host vehicle M on which the vehicle control system 1 according to the first embodiment is mounted. In addition to the finder 20, the radar 30, and the camera 40, the navigation device 50, a vehicle sensor 60, an operation device 70, an operation detection sensor 72, a changeover switch 80, a travel drive force output device 90, a steering device 92, a brake device 94, and the vehicle control device 100 are mounted on the host vehicle M. These devices and apparatuses are connected to each other by a multiplex communication line such as a controller area network (CAN) communication line, a serial communication line, a wireless communication line, and the like.

The navigation device 50 has a global navigation satellite system (GNSS) receiver, map information (navigation map), a touch panel-type display device functioning as a user interface, a speaker, a microphone, and the like. The navigation device 50 identifies the position of the host vehicle M with the aid of the GNSS receiver and derives a route from the position to a destination designated by the user. The route derived by the navigation device 50 is stored in a storage unit 150 as route information 154. The position of the host vehicle M may be identified or compensated by an inertial navigation system (INS) which uses the output of the vehicle sensor 60. Moreover, the navigation device 50 provides guidance for a route to a destination via sound and navigation display when the vehicle control device 100 is operating in a manual driving mode. A configuration for identifying the position of the host vehicle M may be provided independently from the navigation device 50. Moreover, the navigation device 50 may be realized by one function of a terminal device such as a smartphone or a tablet terminal possessed by a user, for example. In this case, the terminal device and the vehicle control device 100 transmit and receive information wirelessly or by cable communication.

The vehicle sensor 60 may be a vehicle speed sensor that detects a vehicle speed, an acceleration sensor that detects an acceleration, a yaw-rate sensor that detects an angular speed around a vertical axis, and an azimuth sensor that detects a direction of the host vehicle M.

The operation device 70 includes an acceleration pedal, a steering wheel, a brake pedal, a shift lever, and the like, for example. An operation detection sensor 72 that detects the presence and the amount of an operation of a driver is attached to the operation device 70. The operation detection sensor 72 includes an acceleration opening sensor, a steering torque sensor, a brake sensor, a shift position sensor, and the like, for example. The operation detection sensors 72 may output an accelerator opening degree, a steering torque, a brake pedal depression amount, a shift position, and the like to a travel control unit 130 as detection results. Instead of this, the detection results of the operation detection sensor 72 may be output directly to the travel drive force output device 90, the steering device 92, or the brake device 94.

The changeover switch 80 is a switch operated by a driver or the like. The changeover switch 80 receives an operation of a driver or the like, generates a control mode designation signal for designating a control mode of the travel control unit 130 as an automatic driving mode or a manual driving mode, and outputs the control mode designation signal to a control switching unit 140. As described above, the automatic driving mode is a driving mode in which a vehicle is traveling in a state in which a driver does not perform operations (or an operation amount is smaller or an operation frequency is lower than in the manual driving mode). More specifically, the automatic driving mode is a driving mode in which some or all of the travel drive force output device 90, the steering device 92, and the brake device 94 are controlled on the basis of an action plan.

The travel drive force output device 90 includes an engine and an engine electronic control unit (ECU) that controls the engine when the host vehicle M is an automobile which uses an internal combustion engine as a power source, includes a travel motor and a motor ECU that controls the travel motor when the host vehicle M is an electric automobile which uses a motor as a power source, and includes an engine, an engine ECU, a travel motor, and a motor ECU when the host vehicle M is a hybrid automobile, for example. When the travel drive force output device 90 includes an engine only, the engine ECU adjusts a throttle opening, a shift step, and the like of the engine according to information input from the travel control unit 130 to be described later and outputs a travel drive force (torque) for allowing the vehicle to travel. Moreover, when the travel drive force output device 90 includes a travel motor only described above, the motor ECU adjusts a duty ratio of a PWM signal supplied to the travel motor according to information input from the travel control unit 130 and outputs the travel drive force. Moreover, when the travel drive force output device 90 includes an engine and a travel motor only, both the engine ECU and the motor ECU control the travel drive force in cooperation according to information input from the travel control unit 130.

The steering device 92 includes an electric motor, for example. The electric motor applies force to a rack-and-pinion function or the like to change the direction of a steering wheel, for example. The steering device 92 drives the electric motor according to the information input from the travel control unit 130 to change the direction of a steering wheel.

The brake device 94 is an electric servo brake device that includes a brake caliper, a cylinder that transmits hydraulic pressure to the brake caliper, an electric motor that generates hydraulic pressure in the cylinder, and a brake control unit, for example. The brake control unit of the electric servo brake device controls the electric motor according to information input from the travel control unit 130 so that a brake torque corresponding to a brake operation is output to respective wheels. The electric servo brake device may include a backup mechanism for transmitting the hydraulic pressure generated by an operation of the brake pedal to the cylinder via a master cylinder. The brake device 94 is not limited to the electric servo brake device described above but may be an electronically controlled hydraulic brake device. The electronically controlled hydraulic brake device controls an actuator according to information input from the travel control unit 130 to transmit the hydraulic pressure of the master cylinder to the cylinder. Moreover, the brake device 94 may include a regenerative brake based on a travel motor included in the travel drive force output device 90.

### [Vehicle Control Device]

Hereinafter, the vehicle control device 100 will be described. The vehicle control device 100 is an example of a “control unit”.

The vehicle control device 100 includes a host vehicle position recognition unit 102, an outside world recognition unit 104, an action plan generation unit 106, a travel mode determining unit 110, a first trajectory generating unit 112, a lane change control unit 120, an operation requesting unit 128, a travel control unit 130, a control switching unit 140, and a storage unit 150, for example. Some or all of the host vehicle position recognition unit 102, the outside world recognition unit 104, the action plan generation unit 106, the travel mode determining unit 110, the first trajectory generating unit 112, the lane change control unit 120, the operation requesting unit 128, the travel control unit 130, and the control switching unit 140 are switch functional units that function when a processor such as a central processing unit (CPU) executes a program. Moreover, some or all of these components may be hardware functional units such as a large scale integration (LSI) or an application specific integrated circuit (ASIC). Moreover, the storage unit 150 is realized by a read only memory (ROM), a random access memory (RAM), a hard disk drive (HDD), a flash memory, or the like. A program executed by a processor may be stored in the storage unit 150 in advance and may be downloaded from an external device via an onboard Internet facility or the like. Moreover, the program may be installed in the storage unit 150 when a portable storage medium having the program stored therein is attached to a drive device (not illustrated). In this way, an onboard computer of the host vehicle M can realize various processes of the first embodiment by cooperation with the hardware functional units and software including programs and the like described above.

The host vehicle position recognition unit 102 recognizes a lane (a traveling lane or a host lane) along which the host vehicle M is traveling and a relative position of the host vehicle M in relation to the traveling lane on the basis of the map information 152 stored in the storage unit 150 and the information input from the finder 20, the radar 30, the camera 40, the navigation device 50, or the vehicle sensor 60. The map information 152 is map information having higher accuracy than the navigation map included in the navigation device 50, for example, and includes information on the center of a lane or information on the boundaries of a lane. More specifically, the map information 152 includes road information, traffic regulations information, address information (an address and a zip code), facility information, telephone number information, and the like. The road information includes information indicating the type of a road such as an expressway, a toll road, a national highway, or a public road and information on the number of lanes of a road, a width of each lane, a gradient of a road, the position of a road (3-dimensional coordinates including a latitude, a longitude, and a height), a curvature of a curve of a lane, the positions of merging and junction points of a lane, and signs provided on a road. The traffic regulations information includes information of blocking of a lane due to roadwork, traffic accidents, congestion, and the like.

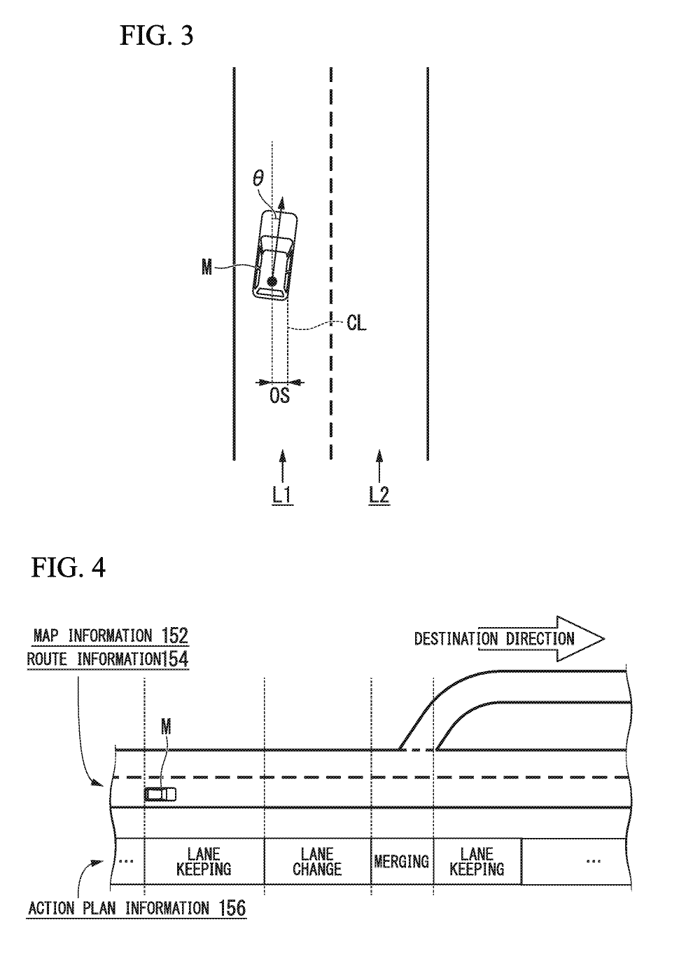

FIG. 3 is a diagram illustrating how the host vehicle position recognition unit 102 recognizes a relative position of the host vehicle M in relation to a traveling lane L1. The host vehicle position recognition unit 102 recognizes a deviation OS of a reference point (for example, the center of gravity) of the host vehicle M from a traveling lane center CL and an angle θ between a traveling direction of the host vehicle M and an extension line of the traveling lane center CL as the relative position of the host vehicle M in relation to the traveling lane L1 (a host lane L), for example. Instead of this, the host vehicle position recognition unit 102 may recognize the position or the like of the reference point of the host vehicle M in relation to either lateral end of the host lane L1 as the relative position of the host vehicle M in relation to the traveling lane.

The outside world recognition unit 104 recognizes the position of a neighboring vehicle and the state thereof such as a speed, an acceleration, or the like on the basis of information input from the finder 20, the radar 30, the camera 40, and the like. A neighboring vehicle in the first embodiment is another vehicle that is traveling around the host vehicle M and a vehicle that is traveling in the same direction as the host vehicle M, for example. For example, the position of a neighboring vehicle may be represented by a representative point such as the center of gravity or a corner of the other vehicle and may be represented by an area represented by an outline of the other vehicle. The “state” of the neighboring vehicle may include information indicating whether a neighboring vehicle is changing an acceleration or lane (or is trying to change lane) on the basis of the information input from various apparatuses. Moreover, the “state” of the neighboring vehicle may include distance information between the host vehicle M and each neighboring vehicle. Moreover, the outside world recognition unit 104 may recognize the position of a guard rail, a telegraph pole, a parked vehicle, a pedestrian, and other objects as well as neighboring vehicles. The host vehicle position recognition unit 102 and the outside world recognition unit 104 described above are examples of a “recognition unit”.

The action plan generation unit 106 sets a starting point of automatic driving and/or a destination of automatic driving. The starting point of automatic driving may be a present position of the host vehicle M and may be a position at which an automatic driving instruction operation is performed. The action plan generation unit 106 generates an action plan in a segment between the starting point and the destination of automatic driving. Without being limited thereto, the action plan generation unit 106 may generate the action plan with respect to an arbitrary segment.

The action plan includes a plurality of events executed sequentially, for example. Examples of the event include a deceleration event of decelerating the host vehicle M, an acceleration event of accelerating the host vehicle M, a lane keeping event of causing the host vehicle M to travel so as not to deviate from a traveling lane, a lane changing event of changing a traveling lane, a passing event of causing the host vehicle M to pass a preceding vehicle, a diverging event of causing the host vehicle M to change its lane to a desired lane at a junction point or travel without deviating from the present traveling lane, and a merging event of accelerating or decelerating the host vehicle M at a merging lane for merging with a main lane to change a traveling lane.

For example, when a junction (a junction point) is present in a toll road (for example, an expressway or the like), the vehicle control device 100 needs to change or maintain a lane so that the host vehicle M travels in the direction for a destination in an automatic driving mode. Therefore, when it is determined that a junction is present on a route by referring to the map information 152, the action plan generation unit 106 sets a lane changing event for changing a lane to a desired lane in which the host vehicle M can travel in the direction for a destination in a segment from the present position (the present coordinates) of the host vehicle M to the position (the coordinates) of the junction. The information indicating the action plan generated by the action plan generation unit 106 is stored in the storage unit 150 as action plan information 156.

FIG. 4 is a diagram illustrating an example of an action plan generated for a certain segment. As illustrated in FIG. 4, the action plan generation unit 106 classifies situations occurring when the host vehicle M travels along a route to a destination and generates an action plan so that events based on the individual situations are executed. The action plan generation unit 106 may change the action plan dynamically according to a change in the situation of the host vehicle M.

The action plan generation unit 106 may change (update) the generated action plan on the basis of an outside state recognized by the outside world recognition unit 104, for example. Generally, the outside state changes constantly while a vehicle is traveling. In particular, when the host vehicle M is traveling on a road including a plurality of lanes, the distance between the host vehicle M and other vehicles relatively changes. For example, when a preceding vehicle brakes abruptly and decelerates or a vehicle traveling on an adjacent lane cuts in front of the host vehicle M, the host vehicle M has to travel while changing the speed and the lane appropriately in harmony with a behavior of a preceding vehicle or a behavior of a vehicle on an adjacent lane. Therefore, the action plan generation unit 106 may change events set for respective control segments according to such a change in the outside state as described above.

Specifically, when the speed of another vehicle recognized by the outside world recognition unit 104 during traveling of the host vehicle exceeds a threshold or a moving direction of another vehicle traveling on a lane (hereinafter referred to as an “adjacent lane”) adjacent to the host lane is directed to the host lane direction, the action plan generation unit 106 may change events set for a driving segment along which the host vehicle M is scheduled to travel. For example, when events are set so that a lane changing event is executed subsequently to a lane keeping event, and it is determined by the recognition result of the outside world recognition unit 104 that a vehicle is traveling at a speed equal to or higher than a threshold from the side behind a lane of a lane change destination during the lane keeping event, the action plan generation unit 106 changes an event subsequent to the lane keeping event from the lane changing event to a deceleration event, a lane keeping event, or the like. As a result, even when a change occurs in the outside state, the vehicle control device 100 can allow the host vehicle M to travel in an automatic driving mode safely.

### [Lane Keeping Event]

The travel mode determining unit 110 determines a travel mode among constant-speed travel, following travel, decelerating travel, curve travel, and obstacle avoidance travel when a lane keeping event included in the action plan is executed by the travel control unit 130. For example, the travel mode determining unit 110 determines a constant-speed travel as a travel mode when another vehicle is not present on the side in front of the host vehicle. Moreover, the travel mode determining unit 110 determines a following travel as a travel mode when the host vehicle follows a preceding vehicle. Moreover, the travel mode determining unit 110 determines a decelerating travel as a travel mode when deceleration of a preceding vehicle is recognized by the outside world recognition unit 104 or the host vehicle performs an event such as stopping or parking. Moreover, the travel mode determining unit 110 determines a curve travel as a travel mode when the outside world recognition unit 104 has recognized that the host vehicle M has arrived in a curved road. Moreover, the travel mode determining unit 110 determines an obstacle avoidance travel as a travel mode when the outside world recognition unit 104 has recognized that an obstacle is present on the side in front of the host vehicle M.

The first trajectory generating unit 112 generates a trajectory on the basis of the travel mode determined by the travel mode determining unit 110. A trajectory is a set (a trajectory) of points obtained by sampling, at predetermined time intervals, future target positions at which the host vehicle M is expected to arrive when the host vehicle M travels on the basis of the travel mode determined by the travel mode determining unit 110. The first trajectory generating unit 112 calculates a target speed of the host vehicle M on the basis of at least the speed of a target object present on the side in front of the host vehicle M recognized by the host vehicle position recognition unit 102 or the outside world recognition unit 104 and the distance between the host vehicle M and the target object. The first trajectory generating unit 112 generates a trajectory on the basis of the calculated target speed. The target object includes a preceding vehicle, a point such as a merging point, a junction point, or a target point, and an obstacle such as an obstacle.

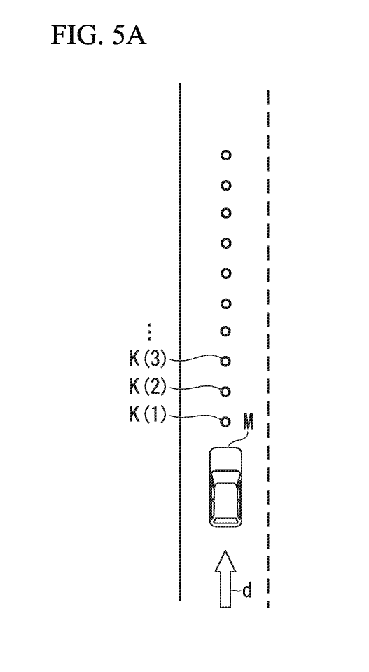

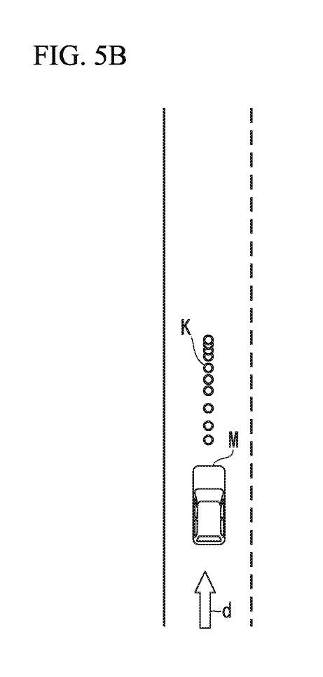

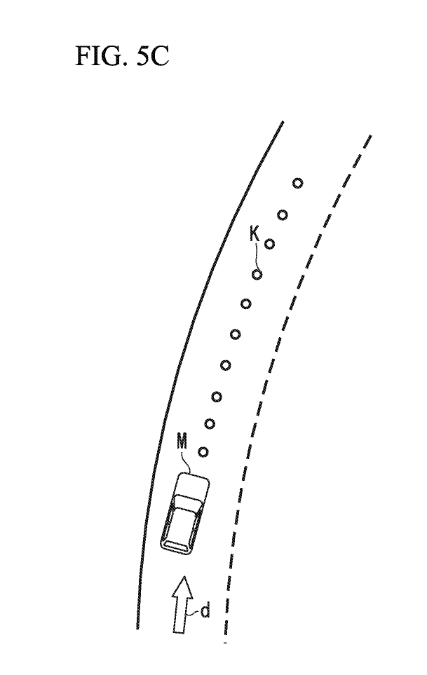

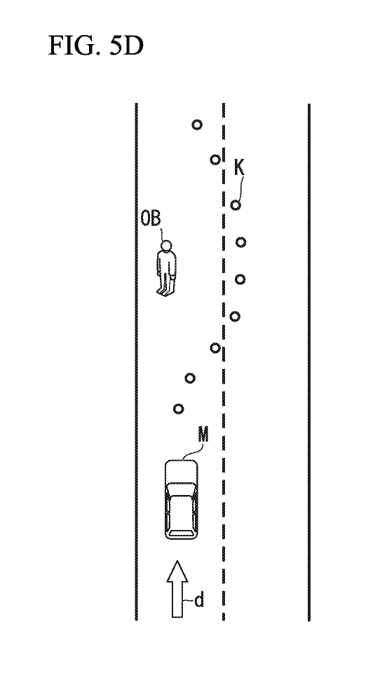

Hereinafter, generation of trajectories in both a case in which the presence of a target object is taken into consideration and a case in which the presence is not taken into consideration will be described. FIGS. 5A to 5D are diagrams illustrating examples of a trajectory generated by the first trajectory generating unit 112. As illustrated in FIG. 5A, for example, the first trajectory generating unit 112 sets future target positions K(1), K(2), K(3), . . . as the trajectory of the host vehicle M using the present position of the host vehicle M as a reference whenever a predetermined time interval At has elapsed from the present time. Hereinafter, these target positions will be referred to simply as a “trajectory point K” when the positions are not distinguished. For example, the number of trajectory points K is determined according to a target time T. For example, when the target time T is 5 seconds, the first trajectory generating unit 112 sets the trajectory point K on the central line of the traveling lane every predetermined time interval At (for example, 0.1 seconds) in the five seconds and determines an arrangement interval of the plurality of trajectory points K on the basis of the travel mode. The first trajectory generating unit 112 may derive the central line of the traveling lane from information such as, for example, the width of a lane included in the map information 152 and may acquire the central line from the map information 152 when the position information of the central line is included in advance in the map information 152.

For example, when a constant-speed travel is determined as the travel mode by the travel mode determining unit 110, the first trajectory generating unit 112 sets a plurality of trajectory points K at equal intervals to generate a trajectory as illustrated in FIG. 5A.

Moreover, when decelerating travel is determined as the travel mode by the travel mode determining unit 110 (including a case in which a preceding vehicle decelerates in following travel), the first trajectory generating unit 112 generates a trajectory such that the earlier the arrival time of the trajectory point K, the wider becomes the interval, and the later the arrival time of the trajectory point K, the narrower becomes the interval as illustrated in FIG. 5B. In this case, a preceding vehicle may be set as a target object and a point such as a merging point, a junction point, or a target point other than the preceding vehicle, an obstacle, or the like may be set as the target object. By doing so, since the trajectory point K of which the arrival time of the host vehicle M is later gets closer to the present position of the host vehicle M, the travel control unit 130 to be described later decelerates the host vehicle M.

As illustrated in FIG. 5C, when the road is a curved road, the travel mode determining unit 110 determines a curve travel as the travel mode. In this case, the first trajectory generating unit 112 arranges the plurality of trajectory points K while changing the lateral position (the position in a lane width direction) with respect to the traveling direction of the host vehicle M according to the curvature of the road, for example, to generate a trajectory. Moreover, as illustrated in FIG. 5D, when an obstacle OB such as a person or a stopped vehicle is present on a road on the side in front of the host vehicle M, the travel mode determining unit 110 determines an obstacle avoidance travel as the travel mode. In this case, the first trajectory generating unit 112 arranges the plurality of trajectory points K so as to travel while avoiding the obstacle OB to generate a trajectory.

### [Lane Changing Event]

The lane change control unit 120 performs control when an event (a lane changing event) of automatically changing a lane included in the action plan is performed by the travel control unit 130. The lane change control unit 120 includes a lane-based speed specifying unit 121, a target position setting unit 122, a lane changeability determining unit 123, a second trajectory generating unit 124, and an interference determining unit 125, for example. The lane change control unit 120 may perform control to be described later when a diverging event or a merging event is performed by the travel control unit 130.

The lane-based speed specifying unit 121 specifies a first vehicle speed on a lane along which the host vehicle M is traveling and a second vehicle speed of a neighboring vehicle that travels along a target lane of a lane change destination. The first vehicle speed is an average vehicle speed obtained from one or a plurality of neighboring vehicles (for example, neighboring vehicles right before and after the host vehicle M) traveling on the host lane, but the first vehicle speed is not limited thereto. For example, the first vehicle speed may be a vehicle speed of the host vehicle M and may be an average vehicle speed of the vehicle speed of the host vehicle M and one or a plurality of neighboring vehicles traveling on the host lane. The second vehicle speed is an average vehicle speed of one or a plurality of neighboring vehicles traveling on the lane of a lane change destination, for example, but the second vehicle speed is not limited thereto. The lane-based speed specifying unit 121 may specify the second vehicle speed using speed information obtained from a predetermined number of (for example, three) neighboring vehicles located closer to the host vehicle M among one or a plurality of neighboring vehicles traveling on the lane of the lane change destination, for example, and may specify the speed of one neighboring vehicle traveling on the lane of the lane change destination as the second vehicle speed.

The lane-based speed specifying unit 121 may specify the first vehicle speed and the second vehicle speed as a fixed value. In this case, the lane-based speed specifying unit 121 may specify a vehicle speed on a traveling lane other than a passing lane as a first fixed value (for example, approximately 80 (km/h)) and may specify a vehicle speed on a passing lane as a second fixed value (for example, 100 (km/h)), for example.

The lane-based speed specifying process of the lane-based speed specifying unit 121 may not be performed repeatedly during traveling of the host vehicle M, and may be performed when the lane changeability determining unit 123 determines that it is not possible to change the lane, for example.

The target position setting unit 122 sets a target position TA for lane change to a lane of a lane change destination to which the host vehicle M automatically changes its lane. For example, the target position setting unit 122 specifies a vehicle that travels on an adjacent lane adjacent to a lane (a host lane) on which the host vehicle M is traveling and travels on the side in front of the host vehicle M and a vehicle that travels on an adjacent lane and travels on the side behind the host vehicle M and sets the target position TA between these vehicles. The adjacent lane is a lane of a lane change destination based on an action plan generated by the action plan generation unit 106, for example. Hereinafter, a vehicle that travels on an adjacent lane and travels on the side in front of the host vehicle M will be referred to as a front reference vehicle, and a vehicle that travels on an adjacent lane and travels on the side behind the host vehicle M will be referred to as a rear reference vehicle. The target position TA is a relative region based on a positional relationship between the host vehicle M, the front reference vehicle, and the rear reference vehicle.

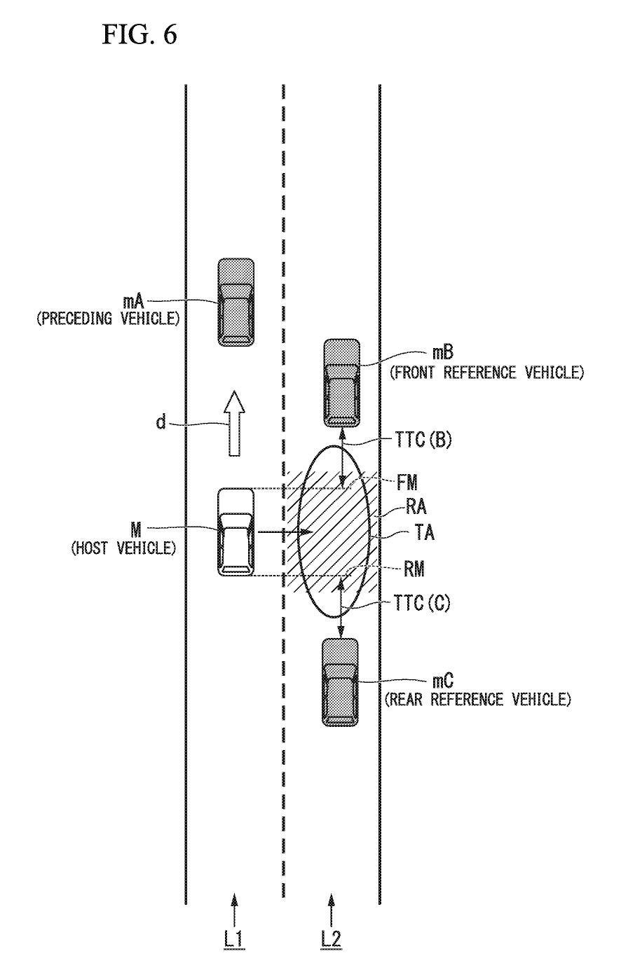

FIG. 6 is a diagram illustrating how the target position setting unit 122 according to the first embodiment sets the target position TA. In FIG. 6, mA indicates a preceding vehicle traveling right before the host vehicle M, mB indicates a front reference vehicle, and mC indicates a rear reference vehicle. Moreover, arrow d indicates a moving (traveling) direction of the host vehicle M, L1 indicates a host lane, and L2 indicates an adjacent lane. In the example of FIG. 6, the target position setting unit 122 sets a target position TA (a first target position) between the front reference vehicle mB and the rear reference vehicle mC on the adjacent lane L2. That is, the front reference vehicle mB is a vehicle traveling right before the target position TA, and the rear reference vehicle mC is a vehicle traveling right after the target position TA.

The target position setting unit 122 changes (resets) the target position when the lane changeability determining unit 123 to be described later determines that it is not possible to change the lane at the present time point.

In this case, the target position setting unit 122 changes the target position (sets a second target position) using the information of the first vehicle speed and the second vehicle speed obtained by the lane-based speed specifying unit 121.

In the first embodiment, the lane changeability determining unit 123 determines that it is possible to change lane as a preliminary determination, for example, when both a first condition in which a neighboring vehicle is not present in a forbidden area set on a lateral side of the host vehicle M and on a lane of the lane change destination and a second condition in which a collision margin time (time to collision: TTC) between the host vehicle M and the neighboring vehicles present before and after the target position is equal to or larger than a threshold are satisfied.

Here, lane changeability determination will be described in detail using FIG. 6. As described above, the lane changeability determining unit 123 determines whether it is possible to change lane to the target position TA (that is, between the front reference vehicle mB and the rear reference vehicle mC) set by the target position setting unit 122. In this case, the lane changeability determining unit 123 projects the host vehicle M to a lane L2 of a lane change destination and sets a forbidden area RA with a small distance margin in a front-rear direction. The forbidden area RA is set as an area extending from one end in a horizontal direction of the lane L2 to the other end.

When a portion of a neighboring vehicle (a front reference vehicle mB or a rear reference vehicle mC) is present in the forbidden area RA, the lane changeability determining unit 123 determines that it is not possible to change lane to the target position TA. The forbidden area RA may be set to an area located “7.0 (m)+offset 4.5 (m)” toward the front side and “7.0 (m)+offset 1.0 (m)” toward the rear side from the center of gravity or the center of the rear wheel shaft of the host vehicle M.

When the neighboring vehicle is not present in the forbidden area RA, the lane changeability determining unit 123 further determines whether it is possible to change lane on the basis of the collision margin time TTC(B) and TTC(C) between the front reference vehicle mB and the rear reference vehicle mC and the host vehicle M.

The lane changeability determining unit 123 draws virtual lines from the front and rear ends of the host vehicle M toward the lane L2 of the lane change destination to create an extension line FM and an extension line RM, as illustrated in FIG. 6, for example.

The lane changeability determining unit 123 calculates the collision margin time TTC(B) between the extension line FM and the front reference vehicle mB and the collision margin time TTC(C) between the extension line RM and the rear reference vehicle mC.

The collision margin time TTC(B) is a time derived by dividing the distance (an inter-vehicle distance) between the extension line FM and the rear end of the front reference vehicle mB by a relative speed between the host vehicle M and the front reference vehicle mB. The collision margin time TTC(C) is a time derived by dividing the distance (an inter-vehicle distance) between the extension line RM and the front end of the rear reference vehicle mC by the relative speed between the host vehicle M and the rear reference vehicle mC. The inter-vehicle distance described above may be calculated on the basis of the center of gravity or the center of the rear wheel shaft of each vehicle.

The lane changeability determining unit 123 determines that the host vehicle M can change its lane to the target position TA when the collision margin time TTC(B) is larger than a threshold Th(B) and the collision margin time TTC(C) is larger than a threshold Th(C) as a preliminary determination. The thresholds Th(B) and Th(C) may be set according to the speed of the host vehicle M and may be set according to a legal speed limit of a traveling road, for example. The thresholds Th(B) and Th(C) may be the same value and may be different values. The thresholds Th(B) and Th(C) are 2.0 (s), for example. A case in which one or both of the front reference vehicle mB and the rear reference vehicle mC is not present may occur. In this case, even if it is not possible to calculate the collision margin time of a vehicle which is not present, the lane changeability determining unit 123 determines that the collision margin time is larger than the threshold and determines whether it is possible to change the lane.

The second trajectory generating unit 124 generates a trajectory for changing the lane to the target position TA when it is determined that the host vehicle M can change the lane to the target position TA as a preliminary determination. Here, the trajectory is a set (a trajectory) of trajectory points K obtained by sampling, at predetermined time intervals, future target positions at which the host vehicle M is expected to arrive when the host vehicle M changes its lane to the lane of the lane change destination.

The lane changeability determining unit 123 may determine whether the host vehicle M can change its lane to the target position TA by taking the speed, the acceleration, the derivative of the acceleration (jerk), and the like of the preceding vehicle mA, the front reference vehicle mB, and the rear reference vehicle mC into consideration. For example, when the speed of the front reference vehicle mB and the rear reference vehicle mC is greater than the speed of the preceding vehicle mA, and it is expected that the front reference vehicle mB and the rear reference vehicle mC will pass the preceding vehicle mA within a time period required for the host vehicle M to change its lane, the lane changeability determining unit 123 may determine that the host vehicle M cannot change its lane to the target position TA set between the front reference vehicle mB and the rear reference vehicle mC.

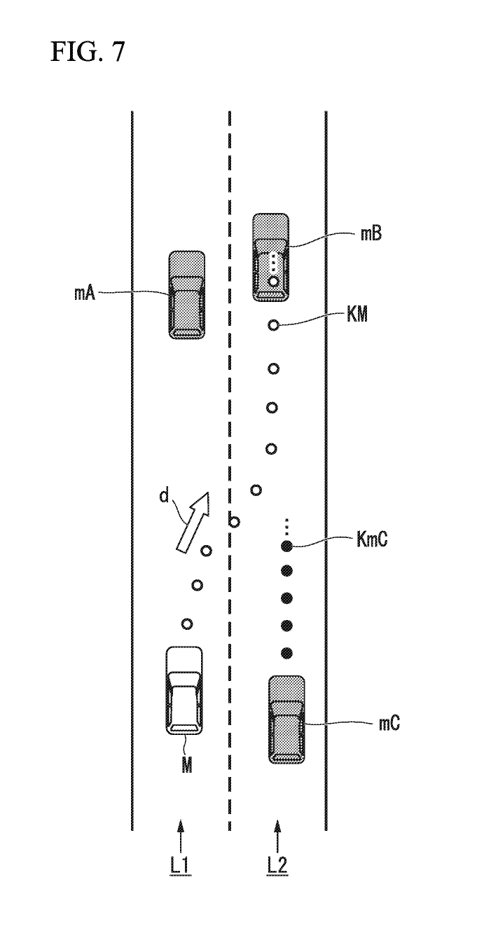

FIG. 7 is a diagram illustrating how the second trajectory generating unit 124 according to the first embodiment generates a trajectory. For example, the second trajectory generating unit 124 generates a trajectory, by assuming that the front reference vehicle mB and the rear reference vehicle mC travel according to predetermined speed models, so that the host vehicle M is present between the front reference vehicle mB and the rear reference vehicle mC at a certain future time so that the host vehicle M does not interfere with the preceding vehicle mA on the basis of the speed of the host vehicle M and the speed models of the three vehicles.

For example, the second trajectory generating unit 124 connects the present point (the present position) of the host vehicle M, the center of the lane of the lane change destination, and a lane changing ending point smoothly using a polynomial curve such as a spline curve and arranges a predetermined number of trajectory points K on this curve at equal or unequal intervals. The trajectory points K may correspond to the trajectory points described above, may include at least one of the trajectory points, and may not include the trajectory points. In this case, the second trajectory generating unit 124 generates a trajectory so that at least one of the trajectory points K is disposed in the target position TA.

The interference determining unit 125 estimates an other-vehicle expected trajectory (for example, KmC illustrated in FIG. 7) based on positions at predetermined future time points of the neighboring vehicle (for example, the rear reference vehicle mC illustrated in FIG. 7). The interference determining unit 125 applies a constant speed model, a constant acceleration model, a constant jerk (derivative of acceleration) model, or the like on the basis of the recognition result of the neighboring vehicle (the rear reference vehicle mC) recognized by the outside world recognition unit 104 and generates an other-vehicle expected trajectory (an other-vehicle estimated trajectory) on the basis of the applied model. The other-vehicle expected trajectory is generated as a set of trajectory points every predetermined time interval At (for example, 0.1 seconds), for example, similarly to the target trajectory of the host vehicle M.

The interference determining unit 125 determines whether the other-vehicle expected trajectory interferes with the target trajectory of the host vehicle M on the basis of the target trajectory of the host vehicle M and the other-vehicle expected trajectory, and specifically, on the basis of the distance between each position on the trajectory of the host vehicle M and the position corresponding in relation to a time point to the position (the trajectory point) on the target trajectory of the host vehicle M among the positions on the trajectory of the neighboring vehicle (the rear reference vehicle mC).

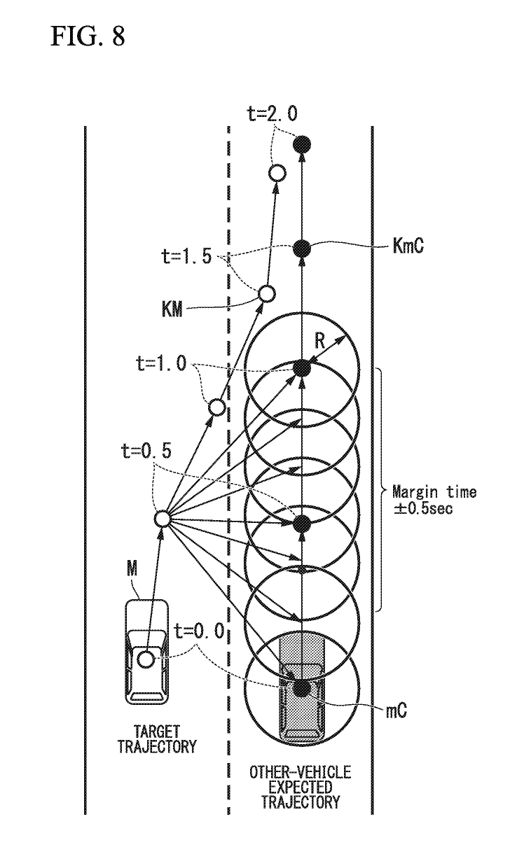

FIG. 8 is a diagram describing interference determination between the target trajectory of the host vehicle M and the other-vehicle expected trajectory. In the example of FIG. 8, although how interference determination is made between the trajectories of the host vehicle M and the rear reference vehicle mC is illustrated, interference determination may be made between the host vehicle M and the preceding vehicle mA or the front reference vehicle mB by a similar method.

For example, the interference determining unit 125 measures an inter-point distance between one or a plurality of trajectory points of the target trajectory of the host vehicle M and the other-vehicle expected trajectory (the former is denoted by KM and the latter is denoted by KmC) and determines whether interference is present.

For example, the interference determining unit 125 extracts trajectory points KmC of the rear reference vehicle mC corresponding to a period between a starting time (T−margin time) which is the time earlier than time point T by the margin time and an ending time (T+margin time) which is the time later than time point T by the margin time with respect to the trajectory point KM of the host vehicle M at the time point T and creates a circle having a predetermined radius R around each of the extracted trajectory points KmC. When the trajectory point KM of the host vehicle M at the time point T is not included in any one of the created circles (or does not make contact with the created circles), it is determined that no interference has occurred at the time point T. The margin time is set to approximately 0.5 (s), for example. The interference determining unit 125 makes such determination at a plurality of future time points. In the example of FIG. 8, determination is made with respect to the trajectory points KM of the host vehicle M at time points of t=0 (s), t=0.5, t=1.0, t=1.5, and t=2.0.

Here, the margin time may be a value that increases as the vehicle speed increases, for example, rather than being a fixed value. Moreover, the size of a circle may be a value that increases as the vehicle speed increases, for example, rather than being a fixed value. Moreover, although interference determination is performed using a circle for the sake of convenience, similar determination can be made by calculating an inter-point distance between the trajectory point KM and the trajectory point KmC.

In the first embodiment, the lane changeability determining unit 123 finally determines that it is possible to change lane as a secondary determination in addition to the preliminary determination when the interference determining unit 125 determines that the target trajectory of the host vehicle M does not interfere with the other-vehicle expected trajectory on the basis of the result of the interference determination between the target trajectory of the host vehicle M and the neighboring vehicle (for example, the front reference vehicle mB and the rear reference vehicle mC). The lane changeability determining unit 123 may determine whether it is possible to change lane by the preliminary determination only without performing the interference determination (a secondary determination) by the interference determining unit 125. Moreover, the lane changeability determining unit 123 may determine whether it is possible to change lane on condition in which an acceleration/deceleration, a turning angle, an expected yaw rate, and the like of each point of the trajectory point KM fall within a predetermined range.

In the first embodiment, the second trajectory generating unit 124 may generate a plurality of lane changing trajectories rather than one lane changing trajectory. Moreover, even when one or a plurality of lane changing trajectories are generated, the second trajectory generating unit 124 continuously generates a trajectory for allowing the host vehicle M to travel while keeping the host lane. The interference determining unit 125 performs interference determination with respect to a plurality of lane changing trajectories. The lane change control unit 120 selects a traveling route and changes the lane when the trajectories of the host vehicle M and the neighboring vehicle do not interfere and there is an optimal short traveling route and selects a lane keeping trajectory to allow the host vehicle M to travel along the host lane continuously when there is not a route along which it is possible to change the lane, for example.

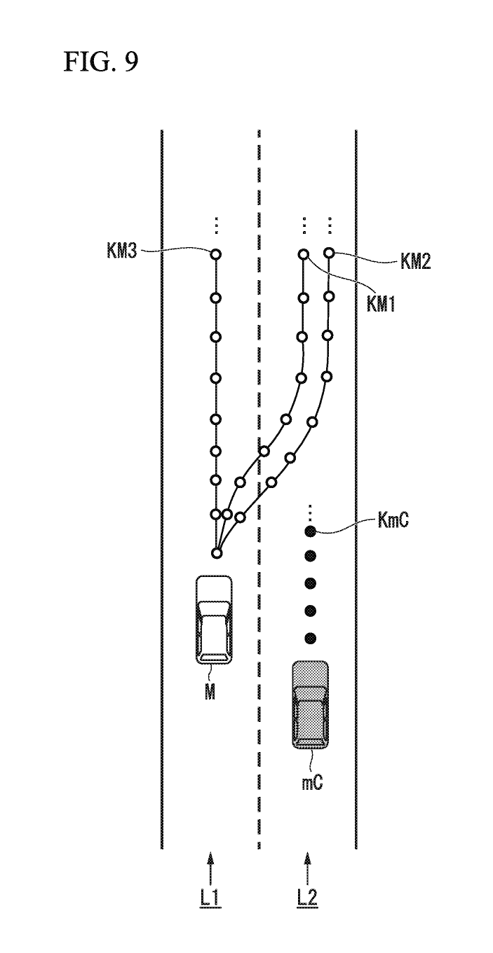

FIG. 9 is a diagram illustrating an example of a trajectory generated when there is a need to change a lane. When there is a need to change lane from the traveling host lane L1 to the lane L2 of the lane change destination, the second trajectory generating unit 124 generates trajectory points (trajectory points KM1 and KM2 illustrated in the example of FIG. 9) corresponding to one or a plurality of lane changing trajectories and generates a trajectory point (a trajectory point KM3 illustrated in the example of FIG. 9) for allowing the host vehicle M to continuously travel while keeping the lane.

For example, when an obstacle OB or the like is present on the side in front of the host lane L1 on which the host vehicle M is traveling, the lane change control unit 120 tries to select any one of the plurality of lane changing trajectories generated by the second trajectory generating unit 124 and changes the lane. When it is possible to change the lane, the host vehicle M changes the lane according to any one of the trajectories based on the trajectory points KM1 and KM2 illustrated in FIG. 9, for example. However, when it becomes not possible to change lane due to an abrupt acceleration of the rear reference vehicle mC illustrated in FIG. 9, for example, the host vehicle M travels according to a lane keeping trajectory (the trajectory points KM3 illustrated in the example of FIG. 9) generated together with the lane changing trajectory.

### [Process Flow]

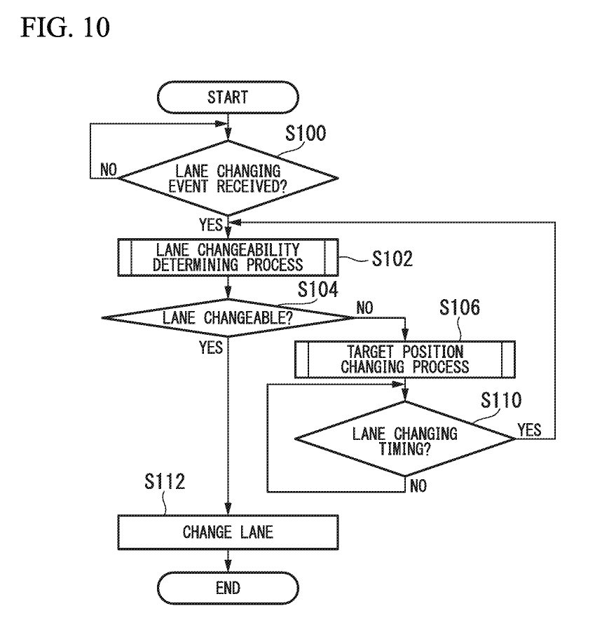

Hereinafter, the flow of the process of the vehicle control device 100 according to the present embodiment will be described. In the following description, the flow of a lane change control process of the host vehicle M among various processes of the vehicle control device 100 will be described. FIG. 10 is a flowchart illustrating an example of a lane change control process. First, the lane change control unit 120 waits until a lane changing event is received from the action plan generation unit 106 (step S100).

Upon receiving the lane changing event, the lane change control unit 120 performs a lane changeability determining process (step S102). The details of the process of this step will be described later.

Subsequently, the lane change control unit 120 determines whether it is possible to change lane on the basis of the processing result of step S102 (step S104). When it is not possible to change the lane, the target position setting unit 122 performs a target position changing process on the basis of the lane-based speed specified by the lane-based speed specifying unit 121 (step S106). Subsequently, the lane change control unit 120 waits until a timing to change lane arrives (step S108).

When the timing to change lane arrives, the lane change control unit 120 returns to step S102.

When it is determined in step S104 that it is possible to change the lane, the lane change control unit 120 causes the travel control unit 130 to output a trajectory and to change lane (step S112).

### [Lane Changeability Determining Process]

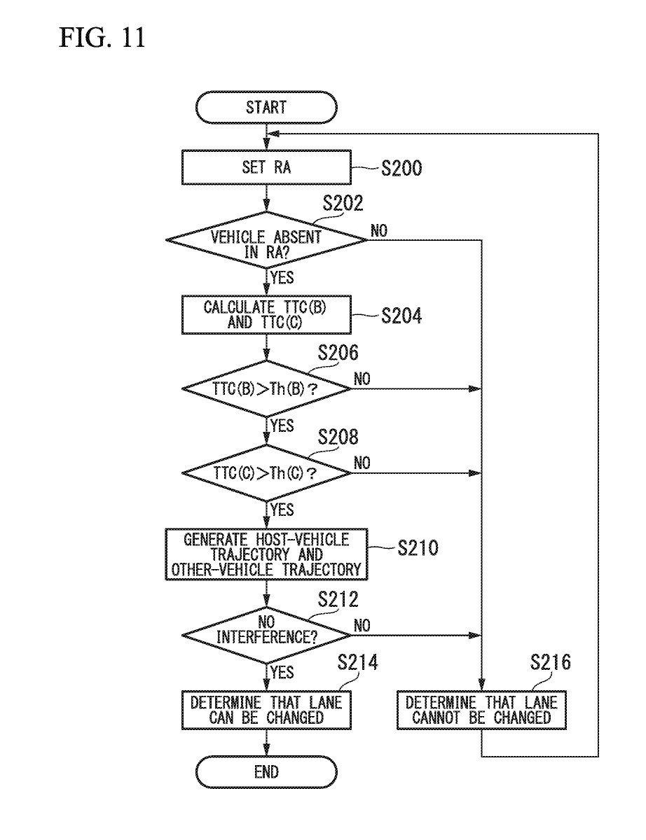

FIG. 11 is a flowchart illustrating an example of a lane changeability determining process according to the first embodiment. The process in FIG. 11 corresponds to the process of step S102 in FIG. 10 described above. First, the lane changeability determining unit 123 sets a forbidden area RA to a lane of a lane change destination (step S200). Subsequently, the lane changeability determining unit 123 determines whether a portion of a neighboring vehicle is present in the forbidden area RA set in step S200 (step S202).

When the neighboring vehicle is not present in the forbidden area RA, the lane changeability determining unit 123 calculates collision margin time TTC(B) and TTC(C) of the front reference vehicle mB and the rear reference vehicle mC (step S204).

Subsequently, the lane changeability determining unit 123 determines whether the TTC(B) of the front reference vehicle mB is larger than the threshold Th(B) (step S206). When TTC(B) is larger than Th(B), the lane changeability determining unit 123 determines whether the TTC(C) of the rear reference vehicle mC is larger than the threshold Th(C) (step S208). When TTC(C) is larger than Th(C), the interference determining unit 125 generates other-vehicle expected trajectories of the preceding vehicle mA, the front reference vehicle mB, and the rear reference vehicle mC (step S210).

Subsequently, the interference determining unit 125 determines whether the target trajectory of the host vehicle M interferes with the other-vehicle expected trajectory (step S212). When the interference determining unit 125 determines that the trajectories do not interfere, the lane changeability determining unit 123 determines that the host vehicle M can change the lane to the lane of the lane change destination (step S214).

On the other hand, when the interference determining unit 125 determines that the trajectories interfere with each other, the lane changeability determining unit 123 determines that it is not possible to change lane (step S216) and the flow returns to the process of step S200. An upper limit may be set to the number of repetition loops, and a determination result that it is not possible to change lane may be returned when the number of repetition loops reaches the upper limit. A determination result that it is not possible to change lane may be returned immediately after it is determined that it is not possible to change lane without returning to the process of step S200.

In this manner, in the first embodiment, since the determination on lane changeability based on the first and second conditions and the determination of the interference determining unit 125 are performed repeatedly during traveling of the host vehicle M, it is possible to determine whether it is possible to change lane appropriately according to a change in a traveling state. In the first embodiment, the processes of steps S210 and S212 of the lane changeability determining process may be omitted.

### [Example of Target Position Changing Process]

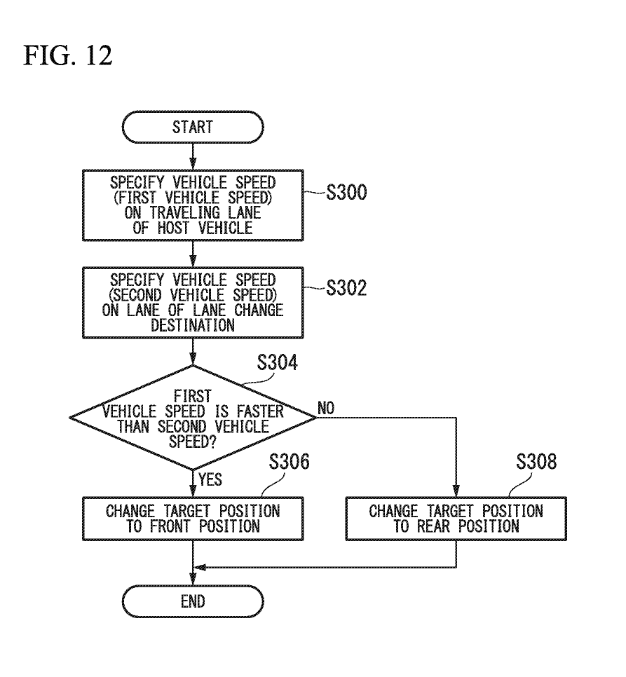

FIG. 12 is a flowchart illustrating an example of a target position changing process. The process of FIG. 12 corresponds to the process of step S106 in FIG. 10. First, the lane-based speed specifying unit 121 specifies a vehicle speed (a first vehicle speed) on the host lane (step S300). Subsequently, the lane-based speed specifying unit 121 specifies a vehicle speed (a second vehicle speed) on the lane of a lane change destination (step S302).

Subsequently, the target position setting unit 122 determines whether the first vehicle speed is faster than the second vehicle speed (step S304). When the first vehicle speed is faster than the second vehicle speed, the target position setting unit 122 changes the target position TA to a position on the front side of the front reference vehicle mB (step S306). On the other hand, when the first vehicle speed is equal to or smaller than the second vehicle speed, the target position TA is changed to a position on the rear side of the rear reference vehicle mC (step S308).

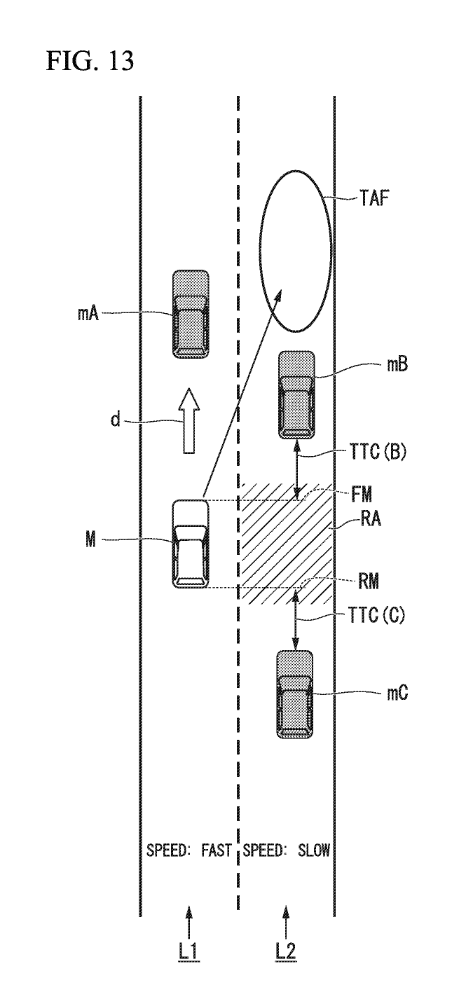

FIG. 13 is a diagram describing how the target position is changed to a front side. The example of FIG. 13 corresponds to the process of step S306. As described above, when it is determined that the host vehicle M cannot change the lane to the lane of a lane change destination, the target position setting unit 122 specifies a vehicle speed (for example, the first vehicle speed and the second vehicle speed) on each lane as described above and changes the target position TA on the basis of a comparison result of the speeds. In the example of FIG. 13, since the first vehicle speed is faster than the second vehicle speed, a target position TAF after change is set to a position on the front side of the front reference vehicle mB.

In this manner, when a new target position TAF is set, the lane change control unit 120 waits until a timing of changing the lane (for example, until the target position TAF reaches the lateral side of the host vehicle M) arrives and performs a lane changing process at a time point at which the lane changing timing is reached. In this case, the lane change control unit 120 may cause the travel control unit 130 to perform speed adjustment control such that the host vehicle M approaches the target position TAF while accelerating the host vehicle M. In this way, it is possible to change lane more quickly.

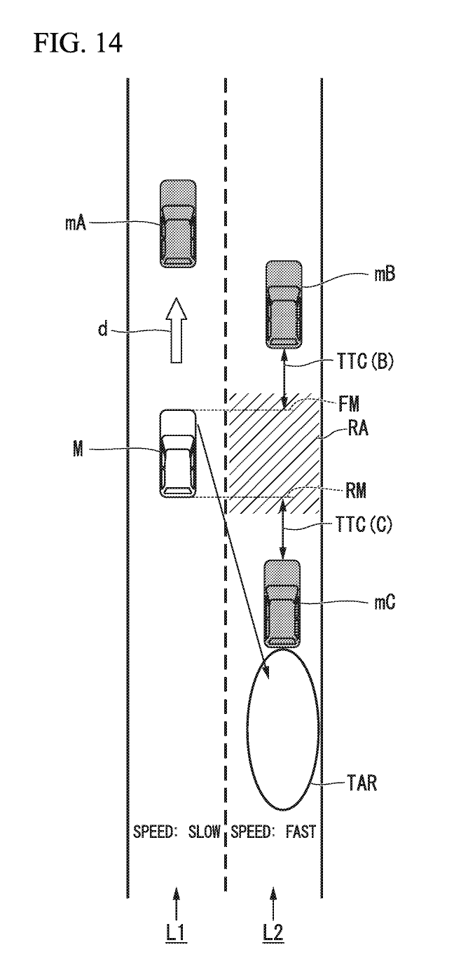

FIG. 14 is a diagram describing how a target position is changed to a side behind. The example of FIG. 14 corresponds to the process of step S308. In the example of FIG. 14, since the first vehicle speed is equal to or smaller than the second vehicle speed, a target position TAR after change is set to a position on the rear side of the rear reference vehicle mC.

In this manner, when a new target position TAR is set, the lane change control unit 120 waits until a timing of changing the lane (for example, until the target position TAR reaches the lateral side of the host vehicle M) arrives and performs a lane changing process at a time point at which the lane changing timing is reached. In this case, the lane change control unit 120 may cause the travel control unit 130 to perform speed adjustment control such that the host vehicle M approaches the target position TAR while decelerating the host vehicle M. In this way, it is possible to change lane more quickly.

The lane change control unit 120 may cause the travel control unit 130 to perform speed adjustment control so that the vehicle speed is equal to the speed (the second vehicle speed) on the lane of the lane change destination or the speed (the speed of either one vehicle or an average speed) of vehicles traveling on the front or rear side of the target position TAR immediately after the target position TAR after change is on the lateral side of the host vehicle. In this way, it is possible to decrease a change in the speed when changing the lane subsequently and to change lane smoothly.

### [Travel Control]

The travel control unit 130 sets the control mode to an automatic driving mode or a manual driving mode according to the control of the control switching unit 140 and controls a control target including some or all of the travel drive force output device 90, the steering device 92, and the brake device 94 according to the set control mode. The travel control unit 130 reads the action plan information 156 generated by the action plan generation unit 106 in the automatic driving mode and controls a control target on the basis of the events included in the read action plan information 156. Moreover, the travel control unit 130 controls acceleration/deceleration and steering of the host vehicle M so that the host vehicle M travels along the generated target trajectory.

For example, when the event is a lane keeping event, the travel control unit 130 determines a control amount (for example, revolutions per minutes) of the electric motor of the steering device 92 and a control amount (for example, an engine throttle opening or a shift step) of the ECU of the travel drive force output device 90 according to the trajectory generated by the first trajectory generating unit 112. Specifically, the travel control unit 130 derives the speed of the host vehicle M in each predetermined time interval At on the basis of the distance between the trajectory points K and the predetermined time interval At when the trajectory points K are arranged and determines the control amount of the ECU of the travel drive force output device 90 according to the speed in each predetermined time interval At. Moreover, the travel control unit 130 determines a control amount of the electric motor of the steering device 92 according to the angle between a traveling direction of the host vehicle M for each trajectory point K and the direction of the next trajectory point with respect to the trajectory point.

When the event is a lane changing event, the travel control unit 130 determines a control amount of the electric motor of the steering device 92 and a control amount of the ECU of the travel drive force output device 90 according to the trajectory generated by the first trajectory generating unit 112 or the second trajectory generating unit 124.

The travel control unit 130 outputs the information indicating the control amount determined for each event to the corresponding control target. In this way, the respective control target devices (90, 92, 94) can control the host devices according to the information indicating the control amount input from the travel control unit 130. Moreover, the travel control unit 130 appropriately adjusts the determined control amount on the basis of the detection result of the vehicle sensor 60.

The travel control unit 130 controls a control target on the basis of operation detection signals output by the operation detection sensor 72 in a manual driving mode. For example, the travel control unit 130 outputs the operation detection signals output by the operation detection sensor 72 to the respective control target devices as they are.

The control switching unit 140 switches the control mode of the host vehicle M by the travel control unit 130 from the automatic driving mode to the manual driving mode or from the manual driving mode to the automatic driving mode on the basis of the action plan information 156 that is generated by the action plan generation unit 106 and stored in the storage unit 150. Moreover, the control switching unit 140 switches the control mode of the host vehicle M by the travel control unit 130 from the automatic driving mode to the manual driving mode or from the manual driving mode to the automatic driving mode on the basis of the control mode designation signal input from the changeover switch 80. That is, the control mode of the travel control unit 130 can be changed arbitrarily by an operation of the driver during traveling or when stopped.

The control switching unit 140 switches the control mode of the host vehicle M by the travel control unit 130 from the automatic driving mode to the manual driving mode on the basis of the operation detection signal input from the operation detection sensor 72. For example, the control switching unit 140 switches the control mode of the travel control unit 130 from the automatic driving mode to the manual driving mode when an operation amount included in the operation detection signal exceeds a threshold (that is, the operation device 70 is operated using an operation amount exceeding a threshold). For example, when the host vehicle M travels in the automatic driving mode due to the travel control unit 130 being set to the automatic driving mode, and the steering wheel, the acceleration pedal, or the brake pedal is operated by the driver with an operation amount exceeding a threshold, the control switching unit 140 switches the control mode of the travel control unit 130 from the automatic driving mode to the manual driving mode. In this way, the vehicle control device 100 can switch to the manual driving mode immediately and not via the operation of the changeover switch 80 according to a prompt operation of the driver when an object such as a person rushes into a driveway and a preceding vehicle stops abruptly. As a result, the vehicle control device 100 can cope with an operation during an emergency using the driver and enhance the safety during traveling.

According to the vehicle control device 100, the vehicle control method, and the vehicle control program according to the first embodiment, it is possible to determine whether it is possible to change lane appropriately on the basis of the presence of a vehicle in the forbidden area RA and the TTC during automatic driving control. Therefore, it is possible to change lane at an appropriate timing according to a traveling state of a vehicle on a lane change destination.

According to the first embodiment, since it is determined that it is possible to change lane when both conditions of the first condition based on the presence of another vehicle in the forbidden area RA and the second condition based on the collision margin time of the host vehicle and the other vehicle are satisfied, it is possible to change lane at a more appropriate timing.

According to the first embodiment, since it is determined whether traveling positions interfere with each other using the predicted trajectories of the host vehicle M and another vehicle traveling on a lane of the lane change destination and the lane is changed on the basis of the determination result, it is possible to determine whether it is possible to change lane more appropriately.

According to the first embodiment, since the lane changeability determination is performed repeatedly, it is possible to determine the lane changeability according to a change in a traveling state.

According to the first embodiment, since the target position is changed on the basis of the first vehicle speed and the second vehicle speed specified by the lane-based speed specifying unit 121 when the lane changeability determining unit 123 determines that it is not possible to change the lane, it is possible to set the target position for lane change more appropriately.

### <Second Embodiment>

Hereinafter, a second embodiment will be described. In the first embodiment, when both conditions of a case (the first condition) where no vehicle is present in the forbidden area and a case (the second condition) where the collision margin time between the host vehicle M and the neighboring vehicle (for example, the front reference vehicle mB and the rear reference vehicle mC) is equal to or larger than a threshold are satisfied, it is determined that the host vehicle M can change the lane to the lane change destination. In the second embodiment, it is determined that the host vehicle M can change the lane to the lane change destination when at least one of a plurality of conditions including the first condition and the second condition is satisfied.

In the second embodiment, since the content of the lane changeability determining process only is different from that of the first embodiment, and the functional configuration and the like are similar to that of the first embodiment, detailed description thereof will be omitted and differences will be mainly described.

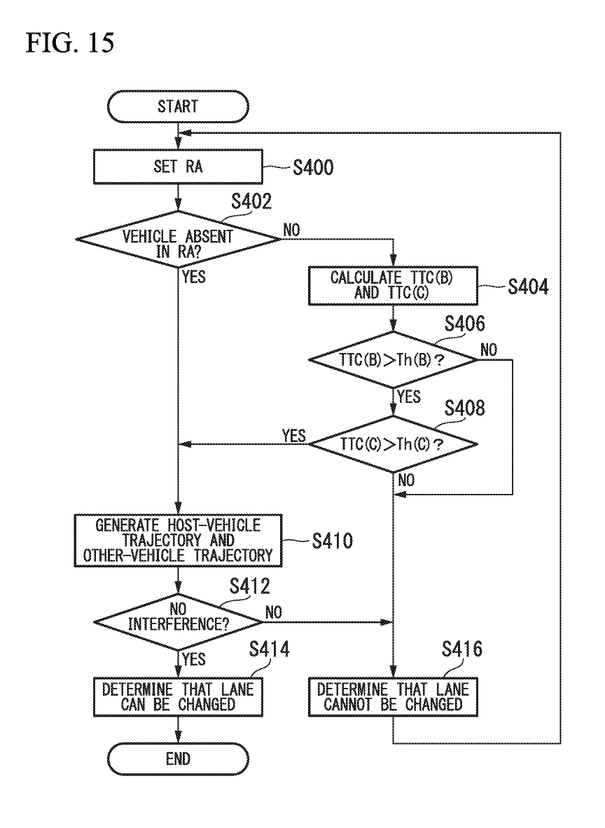

FIG. 15 is a flowchart illustrating an example of a lane changeability determining process according to the second embodiment. In the example of FIG. 15, first, the lane changeability determining unit 123 sets the forbidden area RA to the lane of the lane change destination (step S400). Subsequently, the lane changeability determining unit 123 determines whether a portion of a neighboring vehicle is present in the forbidden area RA set in step S400 (step S402).

Here, in the second embodiment, even when a neighboring vehicle is present in the forbidden area RA, it is determined that it is possible to change lane if a predetermined condition is satisfied for the collision margin time. Therefore, when a portion of the neighboring vehicle is present in the forbidden area RA, the lane changeability determining unit 123 calculates the collision margin time TTC(B) and TTC(C) of the front reference vehicle mB and the rear reference vehicle mC (step S404).

Subsequently, the lane changeability determining unit 123 determines whether the collision margin time TTC(B) is larger than the threshold Th(B) (step S406). When the collision margin time TTC(B) is larger than Th(B), the lane changeability determining unit 123 determines whether the collision margin time TTC(C) is larger than the threshold Th(C) (step S408). When the collision margin time TTC(C) is larger than the threshold Th(C), the interference determining unit 125 generates the expected trajectories (the target trajectory of the host vehicle M and the other-vehicle expected trajectories) from the present positions of the host vehicle M, the front reference vehicle mB, and the rear reference vehicle mC obtained by the first trajectory generating unit 112 (step S410). In the second embodiment, in step S402, when a portion of the neighboring vehicle is not present in the forbidden area RA, the target trajectory of the host vehicle M and the other-vehicle expected trajectories are generated.

Subsequently, the interference determining unit 125 determines whether the host vehicle M and other vehicles (the front reference vehicle mB and the rear reference vehicle mC) interfere with each other on the basis of the trajectories of the host vehicle M and the other vehicles (step S412). When the interference determining unit 125 determines that the vehicles do not interfere, the lane changeability determining unit 123 determines that the host vehicle M can change the lane to the lane change destination (step S414).

On the other hand, when the interference determining unit 125 determines that the vehicles interfere with each other, it is determined that it is not possible to change lane (step S416) and the flow returns to step S400. An upper limit may be set to the number of repetition loops, and a determination result that it is not possible to change lane may be returned when the number of repetition loops reaches the upper limit. A determination result that it is not possible to change lane may be returned immediately after it is determined that it is not possible to change lane without returning to the process of step S400.

According to the vehicle control device 100, the vehicle control method, and the vehicle control program according to the second embodiment, it is determined that it is possible to change lane when the first condition based on the presence of another vehicle in the forbidden area RA is satisfied. Even when the first condition is not satisfied, when the second condition based on the collision margin time of the other vehicle is satisfied, it is possible to determine that it is possible to change the lane. In this way, in the second embodiment, it is possible to broaden the allowable range of the lane changeability as compared to the first embodiment. Moreover, in the second embodiment, the lane changeability determining unit 123 determines that it is not possible to change lane when the first and second conditions are not satisfied. As another embodiment, the lane changeability determining unit 123 may perform the determination based on the first condition when the second condition is not satisfied, for example, and may perform the determination on the lane changeability on the basis of the determination result.

While modes for implementing the present invention have been described using embodiments, the present invention is not limited to these embodiments and various modifications and substitutions can be added without departing from the scope of the present invention.

### [Reference Signs List]

1 Vehicle control system

20 Finder

30 Radar

40 Camera

50 Navigation device

60 Vehicle sensor

70 Operation device

72 Operation detection sensor

80 Changeover switch

90 Travel drive force output device

92 Steering device

94 Brake device

100 Vehicle control device

102 Host vehicle position recognition unit

104 Outside world recognition unit

106 Action plan generation unit

110 Travel mode determining unit

112 First trajectory generating unit

120 Lane change control unit

121 Lane-based speed specifying unit

122 Target position setting unit

123 Lane changeability determining unit

124 Second trajectory generating unit

125 Interference determining unit

130 Travel control unit

140 Control switching unit

150 Storage unit

M Host vehicle

What is claim is:

1. A vehicle control device comprising:
a recognition unit configured to recognize a position of a neighboring vehicle traveling around a host vehicle;
a target position setting unit configured to set a target position for lane change to a lane of a lane change destination to which the host vehicle changes a lane;
a lane changeability determining unit configured to determine that it is possible to change lane when one or both of a first condition in which the neighboring vehicle is not present in a forbidden area which is set on a lateral side of the host vehicle and on the lane of the lane change destination such that a predetermined distance margin is set on a front side and a rear side in relation to the host vehicle and the distance margin on the front side is longer than the distance margin on the rear side and a second condition in which a collision margin time between the host vehicle and the neighboring vehicle present before or after the target position is larger than a threshold are satisfied; and
a control unit configured to cause the host vehicle to change lane to the lane of the lane change destination when the lane changeability determining unit determines that it is possible to change the lane.

2. The vehicle control device according to claim 1, wherein
the lane changeability determining unit determines that it is possible to change lane when both the first condition and the second condition are satisfied, and
the lane changeability determining unit determines that it is not possible to change lane when at least one of the first condition and the second condition is not satisfied.

3. The vehicle control device according to claim 1, wherein
the lane changeability determining unit determines that it is possible to change lane when at least one of the first condition and the second condition is satisfied, and
the lane changeability determining unit determines that it is not possible to change lane when both the first condition and the second condition are not satisfied.

4. The vehicle control device according to claim 1, wherein
the control unit generates a target trajectory of the host vehicle on the basis of positions at predetermined future time points of the host vehicle and controls acceleration/deceleration and steering of the host vehicle so that the host vehicle travels along the target trajectory,
the vehicle control device further includes:
an interference determining unit configured to generate an other-vehicle expected trajectory on the basis of positions at the predetermined future time points of the neighboring vehicle and determines whether the target trajectory of the host vehicle and the other-vehicle expected trajectory interfere with each other on the basis of distances between the positions on the target trajectory of the host vehicle and positions corresponding in relation to time points to the positions on the target trajectory of the host vehicle among positions on the other-vehicle expected trajectory, and
the lane changeability determining unit determines that it is possible to change lane when the interference determining unit determines that the target trajectory of the host vehicle does not interfere with the other-vehicle expected trajectory.

5. The vehicle control device according to claim 4, wherein
the determination on lane changeability using the first condition and the second condition by the lane changeability determining unit and the interference determination by the interference determining unit are performed repeatedly a predetermined number of times.

6. A vehicle control method for causing an onboard computer to execute:
recognizing a position of a neighboring vehicle traveling around a host vehicle;
setting a target position for lane change to a lane of a lane change destination to which the host vehicle changes a lane;
determining that it is possible to change lane when one or both of a first condition in which the neighboring vehicle is not present in a forbidden area which is set on a lateral side of the host vehicle and on the lane of the lane change destination such that a predetermined distance margin is set on a front side and a rear side in relation to the host vehicle and the distance margin on the front side is longer than the distance margin on the rear side and a second condition in which a collision margin time between the host vehicle and the neighboring vehicle present before or after the target position is larger than a threshold are satisfied; and
causing the host vehicle to change lane to the lane of the lane change destination when it is determined that it is possible to change the lane.

7. A vehicle control program for causing an onboard computer to execute processes including:
recognizing a position of a neighboring vehicle traveling around a host vehicle;
setting a target position for lane change to a lane of a lane change destination to which the host vehicle changes a lane;
determining that it is possible to change lane when one or both of a first condition in which the neighboring vehicle is not present in a forbidden area which is set on a lateral side of the host vehicle and on the lane of the lane change destination such that a predetermined distance margin is set on a front side and a rear side in relation to the host vehicle and the distance margin on the front side is longer than the distance margin on the rear side and a second condition in which a collision margin time between the host vehicle and the neighboring vehicle present before or after the target position is larger than a threshold are satisfied; and
causing the host vehicle to change lane to the lane of the lane change destination when it is determined that it is possible to change the lane.

8. The vehicle control device according to claim 1, wherein
the lane changeability determining unit changes the threshold on the basis of a traveling state of the host vehicle and an environment of a road on which the host vehicle is traveling.

9. The vehicle control device according to claim 5, wherein
the lane changeability determining unit determines that it is not possible to change lane when the predetermined number of times reaches an upper limit.
